(19) United States
(12) Patent Application Publication
(10) Pub. No.: US 2025/0232350 A1
(43) Pub. Date: Jul. 17, 2025

(54) ITEM RECOMMENDATION

(71) Applicant: TENCENT TECHNOLOGY (SHENZHEN) COMPANY LIMITED, Shenzhen (CN)

(72) Inventor: Chengfeng LIU, Shenzhen (CN)

(73) Assignee: TENCENT TECHNOLOGY (SHENZHEN) COMPANY LIMITED, Shenzhen (CN)

(21) Appl. No.: 19/169,557

(22) Filed: Apr. 3, 2025

Related U.S. Application Data
(63) Continuation of application No. PCT/CN2023/129771, filed on Nov. 3, 2023.

(30) Foreign Application Priority Data
Feb. 24, 2023 (CN) 202310212088.2

(51) Int. Cl. G06Q 30/0601

(52) U.S. Cl. CPC G06Q 30/0625; G06Q 30/0631

(57) ABSTRACT

Some aspects of the disclosure provide a method of item recommendation. In some examples, a category of a to-be-recommended item is determined based on an item feature of the to-be-recommended item. An association parameter between the category of the to-be-recommended item and a first object is obtained. The association parameter represents an association level between the category of the to-be-recommended item and the first object. A recommendation evaluation parameter of the to-be-recommended item is calculated based on the association parameter and the category of the to-be-recommended item. Whether to recommend the to-be-recommended item to the first object is determined based on the recommendation evaluation parameter. Apparatus and non-transitory computer-readable storage medium counterpart embodiments are also contemplated.

### RELATED APPLICATIONS

The present application is a continuation of International Application No. PCT/CN2023/129771, filed on Nov. 3, 2023, which claims priority to Chinese Patent Application No. 202310212088.2 filed on Feb. 24, 2023. The entire disclosures of the prior applications are hereby incorporated by reference.

### FIELD OF THE TECHNOLOGY

This disclosure relates to the field of computers, including item recommendation.

### BACKGROUND OF THE DISCLOSURE

With the development of artificial intelligence technologies, the technical development focuses on improvement of data processing efficiency and data accuracy. In particular, to recommend an item to a target object, a massive data processing process needs to be performed, and it is difficult to obtain accurate information in the massive data processing process. Consequently, accuracy of an item to be finally recommended is not high, and precise recommendation for the target object cannot be performed, resulting in poor experience of the object.

### SUMMARY

Embodiments of this disclosure provide an item recommendation method and apparatus, an electronic device, a computer-readable storage medium, and a computer program product, to improve accuracy of item recommendation for a target object.

Some aspects of the disclosure provide a method of item recommendation. In some examples, a category of a to-be-recommended item is determined based on an item feature of the to-be-recommended item. An association parameter between the category of the to-be-recommended item and a first object is obtained. The association parameter represents an association level between the category of the to-be-recommended item and the first object. A recommendation evaluation parameter of the to-be-recommended item is calculated based on the association parameter and the category of the to-be-recommended item. Whether to recommend the to-be-recommended item to the first object is determined based on the recommendation evaluation parameter.

Some aspects of the disclosure provide an information processing apparatus. The apparatus includes processing circuitry configured to determine a category of a to-be-recommended item based on an item feature of the to-be-recommended item and obtain an association parameter between the category of the to-be-recommended item and a first object. The association parameter represents an association level between the category of the to-be-recommended item and the first object. The processing circuitry is also configured to calculate a recommendation evaluation parameter of the to-be-recommended item based on the association parameter and the category of the to-be-recommended item. The processing circuitry is configured to determine whether to recommend the to-be-recommended item to the first object based on the recommendation evaluation parameter.

An embodiment of this disclosure further provides an electronic device, including: a processor (e.g., processing circuitry); and a memory, configured to store one or more programs, the one or more programs, when executed by the processor, implementing the foregoing item recommendation method.

An embodiment of this disclosure further provides a computer-readable storage medium (such as a non-transitory computer-readable storage medium), the computer-readable storage medium storing computer-readable instructions, and the computer-readable instructions, when executed by a processor of a computer, enabling the computer to perform the foregoing item recommendation method.

An embodiment of this disclosure further provides a computer program product, including a computer program, the computer program, when executed by a processor, implementing the foregoing item recommendation method.

The embodiments of this disclosure have the following beneficial effects:

The recommendation evaluation parameter of the to-be-recommended item is calculated based on a category of the to-be-recommended item and the degree of association parameter between the category of the to-be-recommended item and an object. The category of the to-be-recommended item and the degree of association between the category of the to-be-recommended item and the object are considered when the recommendation evaluation parameter of the to-be-recommended item is calculated. By introducing a category of an item as an intermediate parameter between the object and the item, a degree of association between data in a data processing process is increased, and accuracy of the calculated recommendation evaluation parameter of the to-be-recommended item is improved, so that the target object can be precisely recommended, accuracy of item recommendation for the target object is improved, and experience of the target object during recommendation is improved.

### BRIEF DESCRIPTION OF THE DRAWINGS

FIG. 1 is a schematic diagram of an implementation environment of an item recommendation method according to an embodiment of this disclosure.

FIG. 2 is a flowchart of an item recommendation method according to an embodiment of this disclosure.

FIG. 3 is a schematic flowchart of another item recommendation method based on the embodiment shown in FIG. 2 according to an embodiment of this disclosure.

FIG. 4 is a schematic flowchart of another item recommendation method based on the embodiment shown in FIG. 3 according to an embodiment of this disclosure.

FIG. 5 is a schematic flowchart of another item recommendation method based on the embodiment shown in FIG. 4 according to an embodiment of this disclosure.

FIG. 6 is a schematic diagram of a process of performing crossing on an item category feature and an item feature according to an embodiment of this disclosure.

FIG. 7 is a schematic flowchart of another item recommendation method based on the embodiment shown in any one of FIG. 2 to FIG. 5 according to an embodiment of this disclosure.

FIG. 8 is a schematic flowchart of another item recommendation method based on the embodiment shown in FIG. 7 according to an embodiment of this disclosure.

FIG. 9 is a schematic flowchart of another item recommendation method based on the embodiment shown in FIG. 8 according to an embodiment of this disclosure.

FIG. 10 is a schematic diagram of a process of generating an object representation vector set and an item representation vector set according to an embodiment of this disclosure.

FIG. 11 is a schematic flowchart of another item recommendation method based on the embodiment shown in FIG. 9 according to an embodiment of this disclosure.

FIG. 12 is a schematic diagram of another process of generating an object representation vector set and an item representation vector set according to an embodiment of this disclosure.

FIG. 13 is a schematic flowchart of another item recommendation method based on the embodiment shown in FIG. 8 according to an embodiment of this disclosure.

FIG. 14 is a schematic flowchart of another item recommendation method based on the embodiments shown in FIG. 2 to FIG. 5 according to an embodiment of this disclosure.

FIG. 15 is a schematic structural diagram of a recall model in the related art.

FIG. 16 is a schematic structural diagram of an item recommendation apparatus according to an embodiment of this disclosure.

FIG. 17 is a schematic structural diagram of a computer system of an electronic device according to an embodiment of this disclosure.

### DESCRIPTION OF EMBODIMENTS

Embodiments are described in detail herein, and examples of the embodiments are shown in the accompanying drawings. When the following descriptions are made with reference to the accompanying drawings, unless otherwise indicated, same numerals in different accompanying drawings represent same or similar elements. Implementations described in the following embodiments do not represent all implementations that are consistent with this disclosure. On the contrary, the implementations are merely examples of apparatuses and methods that are described in detail in the appended claims and that are consistent with some aspects of this disclosure.

Block diagrams shown in the accompanying drawings are merely functional entities and do not necessarily correspond to physically independent entities. In other words, these functional entities may be implemented in a form of software, or these functional entities may be implemented in one or more hardware modules or integrated circuits, or these functional entities may be implemented in different networks and/or processor apparatuses and/or microcontroller apparatuses.

The flowcharts shown in the accompanying drawings are merely example descriptions. The flowcharts do not need to include all content and operations/steps, and do not need to be executed in the described orders either. For example, some operations/steps may be further divided, while some operations/steps may be combined or partly combined. Therefore, an actual execution order may be subject to an actual case.

“Plurality of” mentioned in this disclosure means two or more. “And/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

First, artificial intelligence (AI) is a theory, method, technology, and application system that uses a digital computer or a machine controlled by the digital computer to simulate, extend, and improve human intelligence, perceive an environment, acquire knowledge, and use the knowledge to obtain an optimal result. In other words, AI is a comprehensive technology in computer science and attempts to understand the essence of intelligence and produce a new intelligent machine that may react in a manner similar to human intelligence. AI is to study design principles and implementations of various intelligent machines, to enable the machines to have functions of perception, reasoning, and decision-making.

The AI technology is a comprehensive discipline, and relates to a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning/deep learning.

With the development of the artificial intelligence technologies, when item recommendation is performed for a target object, accurate information needs to be intelligently obtained in a process of processing massive data. However, in the related art, in a process of obtaining information, accuracy of the obtained information is relatively poor, resulting in low accuracy of a finally recommended item. As a result, precise recommendation cannot be performed for the target object, and experience of the object is poor.

Based on this, embodiments of this disclosure provide an item recommendation method and apparatus, an electronic device, a computer-readable storage medium, and a computer program product, to improve accuracy of a recommendation evaluation parameter of a to-be-recommended item, precisely perform recommendation for the target object, and improve the experience of the object.

Refer to FIG. 1. FIG. 1 is a schematic diagram of an implementation environment of an item recommendation method according to an embodiment of this disclosure. As shown in FIG. 1, the implementation environment includes a client 110 and a server 120. The client 110 and the server 120 communicate with each other through a wired or wireless network. A related item recommendation process is exemplarily described as follows.

For example, the client 110 can collect object information of an object (for example, a user), and transmit the collected object information to the server 120 for item recommendation. The object information includes an object feature, for example, a historical behavior feature and a preference behavior feature of the object. The server 120 determines a category of a to-be-recommended item based on an item feature of the to-be-recommended item; obtains a degree of association parameter (also referred to as association parameter) between the category of the to-be-recommended item and the object, the degree of association parameter being configured for representing a degree of association between the category of the to-be-recommended item and the object; calculates a recommendation evaluation parameter of the to-be-recommended item based on the degree of association parameter and the category of the to-be-recommended item; and recommends the to-be-recommended item to the object based on the recommendation evaluation parameter. A recommendation result of whether the to-be-recommended item is recommended is transmitted to the client 110, and the recommendation result is displayed for the object through the client 110. For example, if the recommendation result represents that the to-be-recommended item is recommended, the client 110 displays detailed information of the to-be-recommended item; or if the recommendation result represents that the to-be-recommended item is not recommended, the client 110 does not display the to-be-recommended item.

In an actual application, the client 110 may be disposed in a terminal. The client 110 has an information collection function. The client 110 may collect image information by invoking an image collection component on the terminal, for example, collect a facial image of the object to obtain a facial feature of the object. The object may input related information through the client 110. The terminal may be a smartphone, a notebook computer, a smart tablet, or the like. This is not limited herein. The server 120 may be an independent physical server, or may be a server cluster formed by a plurality of physical servers or a distributed system. The plurality of servers may form a blockchain, and the server is a node on the blockchain. The server 120 may alternatively be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. This is not limited herein. The database may be a physical database, or may be a cloud database located in the cloud. The database may store a large quantity of images, so that each end obtains corresponding images from the database. This is not limited herein either.

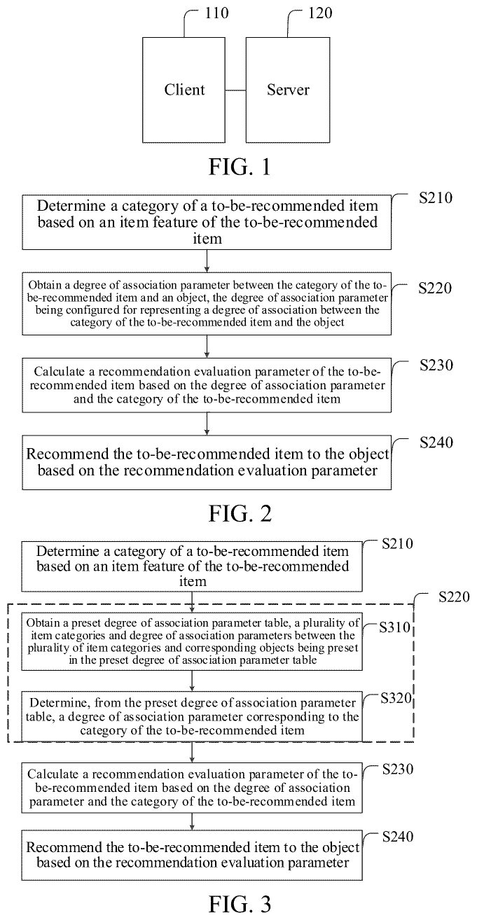

Refer to FIG. 2. FIG. 2 is a flowchart of an item recommendation method according to an embodiment of this disclosure. In an actual application, the method may be implemented by a server and a terminal in cooperation, or may be separately implemented by the server or the terminal, for example, executed by the server 120 in the implementation environment shown in FIG. 1. Certainly, the method may alternatively be applied to another implementation environment, and is performed by a server device in the another implementation environment. This is not limited in this embodiment.

The item recommendation method provided in this embodiment is described below by using the server as an example of an execution body. As shown in FIG. 2, the method includes at least S210 to S240. Details are described as follows:

S210: Determine a category of a to-be-recommended item based on an item feature of the to-be-recommended item.

The to-be-recommended item may be a commodity or a non-commodity, and the to-be-recommended item may be an actual item entity, such as clothes or shoes, or may be a virtual item, such as a video or a song.

The item feature may be a feature configured for representing an item attribute, a use, an appearance, and the like. The item may be classified based on the item feature, to determine a category of the item. For example, an image item is classified into a video, a picture, music, and the like based on the item attribute.

For example, when the to-be-recommended item is multimedia information, the item category of the to-be-recommended item may be determined based on a quantity of image frames, whether there is audio, an audio track, and the like. For example, a quantity of frames of the to-be-recommended item is obtained. If the quantity of frames of the to-be-recommended item is a singular number, and there is no audio, an audio track, or the like to be output, it is determined that the item category of the to-be-recommended item is a picture.

In some embodiments, the item feature of the to-be-recommended item may be obtained in the following manner: obtaining item information of a to-be-recommended item, and performing feature extraction on the item information to obtain the item feature of the to-be-recommended item. The item information of the to-be-recommended item may include at least one of the following: a name of the to-be-recommended item, an item label carried by the to-be-recommended item, an image of the to-be-recommended item, and description information configured for describing the to-be-recommended item.

In some embodiments, based on the item feature of the to-be-recommended item, the category of the to-be-recommended item may be determined in the following manner: mapping the item feature of the to-be-recommended item, to obtain the category of the to-be-recommended item. In an actual application, the mapping processing may be implemented through training to obtain a classification model.

S220: Obtain a degree of association parameter between the category of the to-be-recommended item and an object, the degree of association parameter being configured for representing a degree of association between the category of the to-be-recommended item and the object.

In an actual application, a to-be-recommended item library may be provided. The to-be-recommended item library includes a plurality of items. The plurality of items may belong to a plurality of categories. There is an association between each item category and an object, and a degree of association parameter represents a degree of association between the two (namely, the object and the item category). For example, if the object is a female, an item category A is women's clothing, and an item category B is men's clothing, a degree of association between the item category A and the object is greater than a degree of association between the item category B and the object.

In some embodiments, the degree of association parameter between the category of the to-be-recommended item and the object may be obtained in the following manner: obtaining a category feature of the category of the to-be-recommended item, and obtaining an object feature of the object, to determine the degree of association parameter between the category of the to-be-recommended item and the object based on the category feature and the object feature.

In an actual application, based on the category feature and the object feature, the degree of association parameter between the category of the to-be-recommended item and the object may be determined in the following manner: calculating a similarity between the category feature of the category of the to-be-recommended item and the object feature of the object, and determining the calculated similarity as the degree of association parameter between the category of the to-be-recommended item and the object. A larger degree of association parameter indicates a higher degree of association between the category of the to-be-recommended item and the object.

In some embodiments, based on an item category feature of the item category and the object feature of the object, the degree of association parameter between the category of the to-be-recommended item and the object may be determined in the following manner: concatenating the item category feature of the item category and the object feature of the object, to obtain a concatenated feature; and inputting the concatenated feature into a degree of association prediction model that is obtained through training, and predicting the degree of association parameter between the category of the to-be-recommended item and the object through the degree of association prediction model, to obtain the degree of association parameter between the category of the to-be-recommended item and the object.

S230: Calculate a recommendation evaluation parameter of the to-be-recommended item based on the degree of association parameter and the category of the to-be-recommended item.

The recommendation evaluation parameter represents a matching degree between the to-be-recommended item and the object. A larger recommendation evaluation parameter indicates a higher matching degree between the to-be-recommended item and the object, and a higher matching degree represents that the to-be-recommended item is more suitable for recommendation to the object.

For example, the degree of association parameter and the category of the to-be-recommended item are separately scored, a recommendation evaluation score is calculated based on scores of the degree of association parameter and the category of the to-be-recommended item, and the recommendation evaluation score is used as the recommendation evaluation parameter of the to-be-recommended item.

In this embodiment, the recommendation evaluation parameter of the to-be-recommended item is calculated based on the category of the to-be-recommended item and the degree of association parameter between the category of the to-be-recommended item and the object. In this embodiment, a category of an item is introduced as an intermediate parameter between the object and the item, to increase a degree of association between data in a data processing process. This improves accuracy of the recommendation evaluation parameter of the to-be-recommended item, so that precise recommendation is performed for the target object, and experience of the object is improved.

A process of obtaining the degree of association parameter between the category of the to-be-recommended item and the object is described. In some embodiments, referring to FIG. 3, FIG. 3 is a schematic flowchart of another item recommendation method based on the embodiment shown in FIG. 2. The method in this embodiment is included in S220 shown in FIG. 2, and includes S310 and S320. Details are described as follows:

S310: Obtain a preset degree of association parameter table (also referred to as preset association parameter table), a plurality of item categories and degree of association parameters between the plurality of item categories and corresponding objects being preset in the preset degree of association parameter table.

The preset degree of association parameter table is a preset table, where each item category in the table corresponds to a degree of association parameter with a target object. For example, as shown in Table 1, Table 1 is a preset degree of association parameter table, where the object is in a first dimension, the item category is in a second dimension, and a target degree of association parameter is determined based on the two dimensions.

TABLE 1

| Item category | Object A | Object B | Object C | Object D |
|---|---|---|---|---|
| Item category A | Degree of | Degree of | Degree of | Degree of |
| | association | association | association | association |
| | parameter AA | parameter AB | parameter AC | parameter AD |
| Item category B | Degree of | Degree of | Degree of | Degree of |
| | association | association | association | association |
| | parameter BA | parameter BB | parameter BC | parameter BD |
| Item category C | Degree of | Degree of | Degree of | Degree of |
| | association | association | association | association |
| | parameter CA | parameter CB | parameter CC | parameter CD |

S320: Determine, from the preset degree of association parameter table, a degree of association parameter corresponding to the category of the to-be-recommended item.

For example, if the category of the to-be-recommended item is the item category C, and the object is the object A, it may be obtained from Table 1 that a degree of association parameter between the item category C and the object A is the degree of association parameter CA.

By substituting the object and the category of the to-be-recommended item into the preset degree of association parameter table, the degree of association parameter between the category of the to-be-recommended item and the object may be quickly obtained, thereby improving efficiency of a parameter obtaining process.

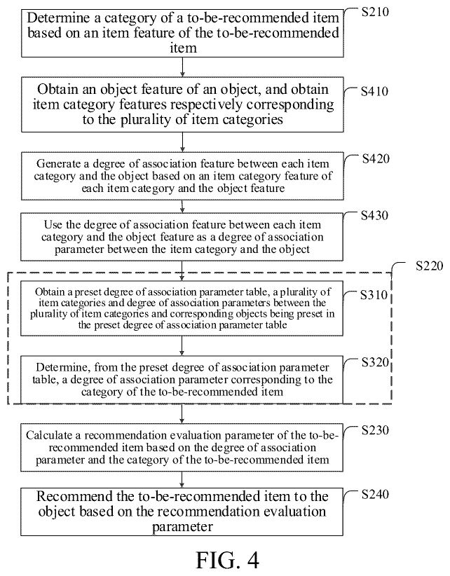

For a process of obtaining a degree of association parameter between each item category and the object, refer to FIG. 4. FIG. 4 is a schematic flowchart of another item recommendation method based on the embodiment shown in FIG. 3. In this embodiment, the method further includes at least S410 to S430 before S310 shown in FIG. 3. Details are described as follows:

S410: Obtain an object feature of the object, and obtain item category features respectively corresponding to the plurality of item categories.

The object feature may include a facial feature, a gender feature, a behavior feature, and the like of the object. The object feature of the object may be obtained by performing feature extraction on object information of the object. The object information may include a facial image, a gender, an age, a historical social record (for example, a historical purchasing behavior record), and the like of the object. The item category feature may be a feature configured for representing a category to which the item belongs.

Each object may have a plurality of object features. Because one item may belong to a plurality of different item categories, and correspondingly, each item may also correspond to a plurality of item category features. For example, an item A corresponds to a first item category feature, a second item category feature, and a third item category feature.

S420: Generate a degree of association feature (also referred to as association feature) between each item category and the object based on an item category feature of each item category and the object feature.

In an actual application, the following processing may be performed for each item category: generating a degree of association feature between the item category and the object based on the item category feature of the item category and the object feature of the object, where the degree of association feature can indicate a degree of association between the object and the item category.

For example, one item category corresponds to three item category features, and the degree of association feature between the item category and the object is generated based on the three item category features and the object feature.

In some embodiments, based on the item category feature of the item category and the object feature of the object, the degree of association feature between the item category and the object may be generated in the following manner: performing feature crossing on the item category feature of the item category and the object feature of the object, to obtain a cross feature as the degree of association feature between the item category and the object.

The object feature may include a behavior feature and an item feature associated with the behavior feature. In this way, in an actual application, feature crossing may be performed on the item category feature of the item category and the item feature associated with the behavior feature to obtain the degree of association feature.

S430: Use the degree of association feature between each item category and the object feature as a degree of association parameter between the item category and the object.

In this embodiment of this disclosure, the degree of association feature is directly used as the degree of association parameter, and the degree of association between the item category and the object is more intuitively represented by using the degree of association feature.

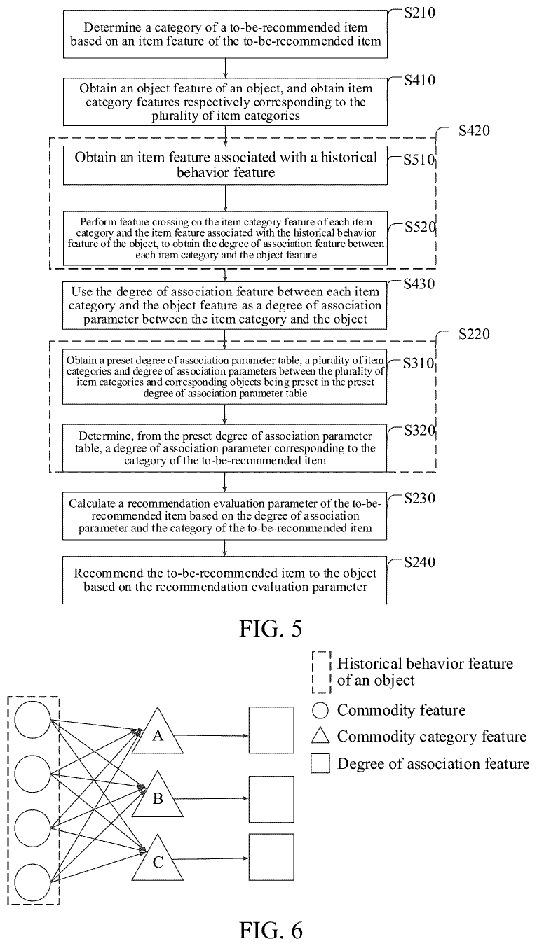

Continue to describe S420. For a process of generating the degree of association feature, refer to FIG. 5. FIG. 5 is a schematic flowchart of another item recommendation method based on the embodiment shown in FIG. 4. The method in this embodiment is included in S420 shown in FIG. 4, and further includes at least S510 and S520. The object feature includes a historical behavior feature of the object. Details are described as follows:

S510: Obtain an item feature associated with the historical behavior feature.

A historical operation behavior of the object may record the historical behavior feature of the object, and record the item feature associated with the historical behavior feature. For example, when the object browses items, an item clicked/tapped by the object is recorded, and an item feature of the item is recorded.

S520: Perform feature crossing on the item category feature of each item category and the item feature associated with the historical behavior feature of the object, to obtain the degree of association feature between each item category and the object feature.

The crossing is to mark and associate the item category feature with the item feature. For example, feature crossing is performed on an item feature A and an item feature B that are associated with the historical behavior feature of the object and three item category features, to obtain three degree of association features.

This embodiment is exemplarily described as follows. Refer to FIG. 6. FIG. 6 is a schematic diagram of a process of performing feature crossing on an item category feature and an item feature that is associated with a historical behavior feature of an object. A rectangle represents the historical behavior feature of the object; a circle represents an item feature associated with the historical behavior feature of the object; and a triangle represents an item category feature.

As shown in FIG. 6, feature crossing is performed on four item features and an item category feature A, to obtain a degree of association feature between the item category feature A and an object feature; feature crossing is performed on the four item features and an item category feature B, to obtain a degree of association feature between the item category feature B and the object feature; and feature crossing is performed on the four item features and an item category feature C, to obtain a degree of association feature between the item category feature C and the object feature.

In this embodiment, feature crossing is performed on the item feature associated with the historical behavior feature of the object and each item category feature, to obtain a degree of association feature between each item category and the object feature, and establish an association between the item category and the object, so that importance of the object in different item categories is illustrated.

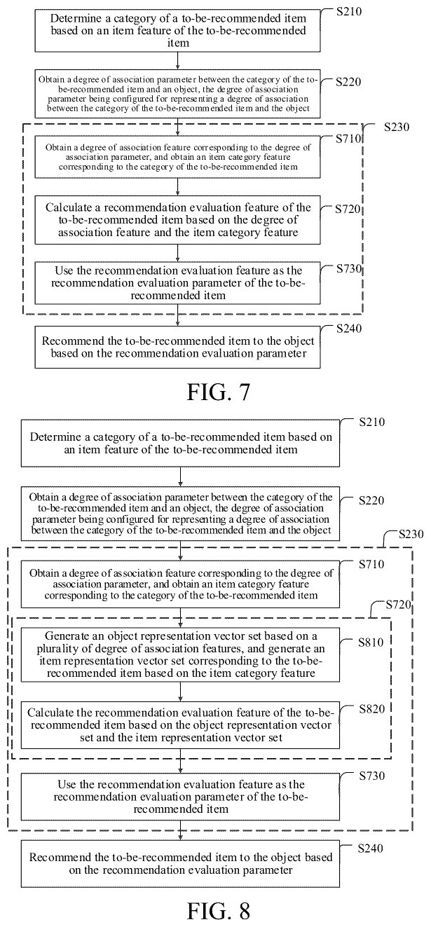

For descriptions of how to calculate a recommendation evaluation parameter of a to-be-recommended item, refer to FIG. 7. FIG. 7 is a schematic flowchart of another item recommendation method based on the embodiment shown in any one of FIG. 2 to FIG. 5. The method in this embodiment is included in S230, and further includes at least S710 to S730. Details are described as follows:

S710: Obtain a degree of association feature corresponding to the degree of association parameter, and obtain an item category feature corresponding to the category of the to-be-recommended item.

The degree of association feature can represent a feature of the entire degree of association parameter to a certain extent. For example, the degree of association feature represents a degree of association of the degree of association parameter, a value of the parameter, complexity of the parameter, and the like.

S720: Calculate a recommendation evaluation feature of the to-be-recommended item based on the degree of association feature and the item category feature.

For example, the degree of association feature and the item category feature are quantified, to calculate, based on obtained two values, a value corresponding to the recommendation evaluation feature of the to-be-recommended item. A calculation process is not limited in this embodiment of this disclosure.

S730: Use the recommendation evaluation feature as the recommendation evaluation parameter of the to-be-recommended item.

For example, if the recommendation evaluation feature is a constant value, the recommendation evaluation parameter of the to-be-recommended item is a constant value.

This embodiment provides a manner for calculating the recommendation evaluation parameter of the to-be-recommended item. The degree of association feature corresponding to the degree of association parameter and the item category feature corresponding to the category of the to-be-recommended item are obtained, so that the recommendation evaluation feature of the to-be-recommended item is accurately calculated, and the recommendation evaluation feature is used as the recommendation evaluation parameter of the to-be-recommended item, thereby improving accuracy of the recommendation evaluation parameter of the to-be-recommended item.

For descriptions of a process of calculating the recommendation evaluation feature of the to-be-recommended item based on the degree of association feature and the item category feature, refer to FIG. 8. FIG. 8 is a schematic flowchart of another item recommendation method based on the embodiment shown in FIG. 7. The method in this embodiment is included in S720 shown in FIG. 7, and further includes at least S810 and S820. There are a plurality of degree of association features. Details are described as follows:

S810: Generate an object representation vector set based on the plurality of degree of association features, and generate an item representation vector set corresponding to the to-be-recommended item based on the item category feature.

The object representation vector set includes a plurality of object representation vectors, and is generated based on the plurality of degree of association features. One degree of association feature is configured for generating one object representation vector, that is, a quantity of degree of association features is the same as a quantity of object representation vectors in the object representation vector set.

In this embodiment, the item category feature is an item category feature corresponding to the to-be-recommended item, and the item representation vector set corresponding to the to-be-recommended item is generated based on the item category feature. The item representation vector set includes at least one item representation vector.

S820: Calculate the recommendation evaluation feature of the to-be-recommended item based on the object representation vector set and the item representation vector set.

A corresponding vector calculation result is calculated based on a vector in the object representation vector set and an item representation vector at a corresponding location in the item representation vector set, to calculate the recommendation evaluation feature of the to-be-recommended item based on the vector calculation result.

This embodiment shows a manner for calculating the recommendation evaluation feature of the to-be-recommended item. The object representation vector set is generated based on the plurality of degree of association features, and the item representation vector set corresponding to the to-be-recommended item is generated based on the item category feature, to accurately calculate the recommendation evaluation feature of the to-be-recommended item.

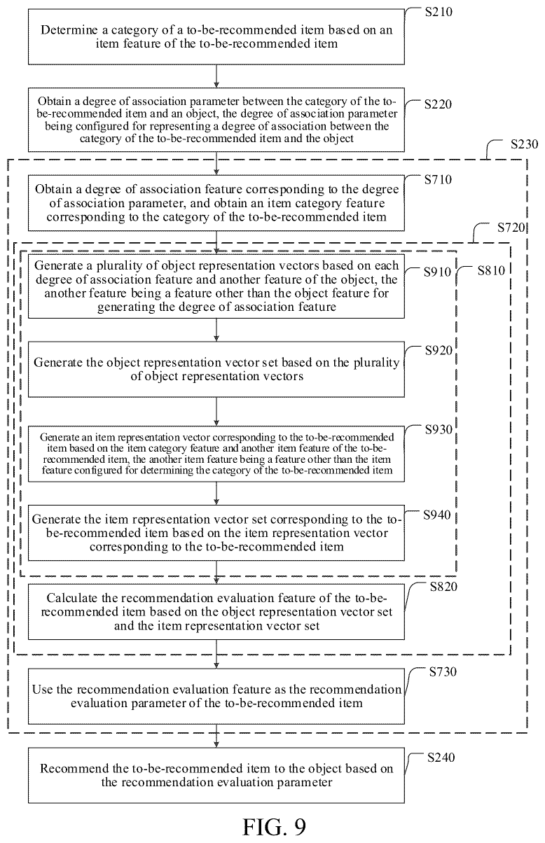

To improve accuracy of the object representation vector set and the item representation vector set, other impact factors need to be further considered. Therefore, another feature of the object and another item feature are introduced in another embodiment of this disclosure. Refer to FIG. 9. FIG. 9 is a schematic flowchart of another item recommendation method based on the embodiment shown in FIG. 8. The method in this embodiment is included in S810 shown in FIG. 8, and further includes S910 to S940. Details are described as follows:

S910: Generate a plurality of object representation vectors based on each degree of association feature and another feature of the object, the another feature being a feature other than the object feature for generating the degree of association feature.

For example, there are three degree of association features. A first object representation vector is generated based on a first degree of association feature and the another feature of the object; a second object representation vector is generated based on a second degree of association feature and the another feature of the object; and a third object representation vector is generated based on a third degree of association feature and the another feature of the object. In this embodiment, the another feature of the object is considered when the plurality of object representation vectors are generated, so that the plurality of object representation vectors generated are more relevant to the object.

For example, the degree of association feature is a quantity of times of clicking/tapping the item category corresponding to the to-be-recommended item in a sequence of the historical behavior of the object. The another feature of the object may be a gender feature or an age feature of the object.

S920: Generate the object representation vector set based on the plurality of object representation vectors.

The object representation vector set includes the plurality of object representation vectors, in other words, a quantity of vectors in the object representation vector set is determined based on a quantity of object representation vectors.

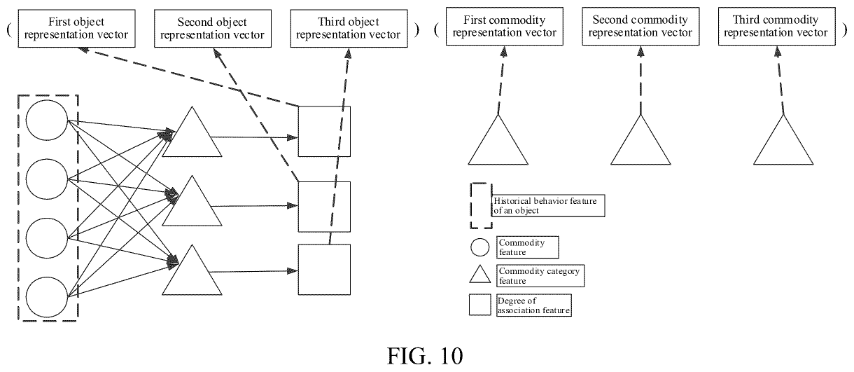

S910 and S920 are exemplarily described as follows. Refer to FIG. 10. FIG. 10 is a schematic diagram of a process of generating an object representation vector set and an item representation vector set. As shown in FIG. 10, feature crossing is performed on the item feature associated with the historical behavior feature of the object and each item category feature, to obtain three degree of association features; the first object representation vector, the second object representation vector, and the third object representation vector are respectively generated based on the three degree of association features and the another item features; and the first object representation vector, the second object representation vector, and the third object representation vector re sequentially sorted to form the object representation vector set. Similarly, the following item representation vector set is generated.

S930: Generate an item representation vector corresponding to the to-be-recommended item based on the item category feature and another item feature of the to-be-recommended item, the another item feature being a feature other than the item feature configured for determining the category of the to-be-recommended item.

For example, crossing is performed on the item category feature of the to-be-recommended item and the another item feature to generate an item representation vector with a strong degree of association between the item category feature of the to-be-recommended item and the another item feature. In this embodiment, the another item feature is considered when the item representation vector corresponding to the to-be-recommended item is generated, so that the degree of association between the item category feature and the item feature is improved.

S940: Generate the item representation vector set corresponding to the to-be-recommended item based on the item representation vector corresponding to the to-be-recommended item.

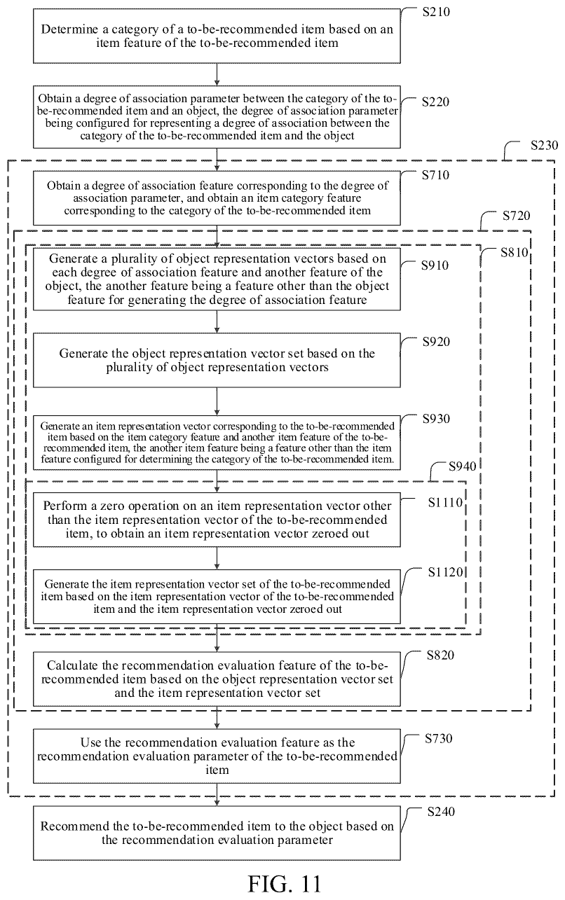

A quantity of vectors in the item representation vector set corresponding to the to-be-recommended item is different from a quantity of vectors in the object representation vector set. To facilitate a subsequent operation on the vector sets, for improvement on the item representation vector set in another embodiment of this disclosure, refer to FIG. 11. FIG. 11 is a schematic flowchart of another item recommendation method based on the embodiment shown in FIG. 9. The method in this embodiment is included in S940 shown in FIG. 9, and further includes S1110 and S1120. Details are described as follows:

S1110: Perform a zero operation on an item representation vector other than the item representation vector of the to-be-recommended item, to obtain an item representation vector zeroed out.

For example, the item category feature of the to-be-recommended item is generated, and the item representation vector of the to-be-recommended item is generated based on the item category feature and the another item feature, so that a location of the item representation vector in the item representation vector set corresponds to a location of an associated object representation vector, and a zero value is assigned to another item representation vector.

S1120: Generate the item representation vector set of the to-be-recommended item based on the item representation vector of the to-be-recommended item and the item representation vector zeroed out.

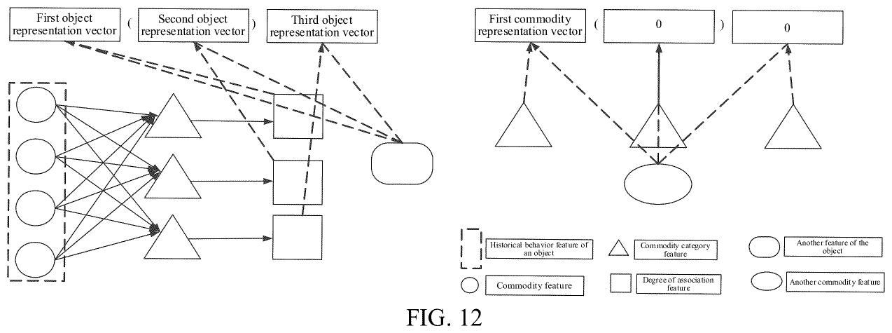

For example, referring to FIG. 12, FIG. 12 is a schematic diagram of another process of generating an object representation vector set and an item representation vector set. The first item representation vector is an item representation vector of the to-be-recommended item. A process of generating the first item representation vector is substantially the same as the generation process shown in FIG. 10, and a difference lies in that when the item representation vector set is generated, a zero operation is performed on the item representation vector other than the item representation vector of the to-be-recommended item, that is, a zero value is assigned to the another item representation vector.

In this embodiment, when it is ensured that the quantity of vectors in the item representation vector set is equal to the quantity of vectors in the object representation vector set, a zero operation is performed on another item representation vector other than the item representation vector of the to-be-recommended item. In a subsequent process of calculating the object representation vector set and the item representation vector set, a calculation speed may be increased to avoid a waste of calculation resources and improve data processing efficiency.

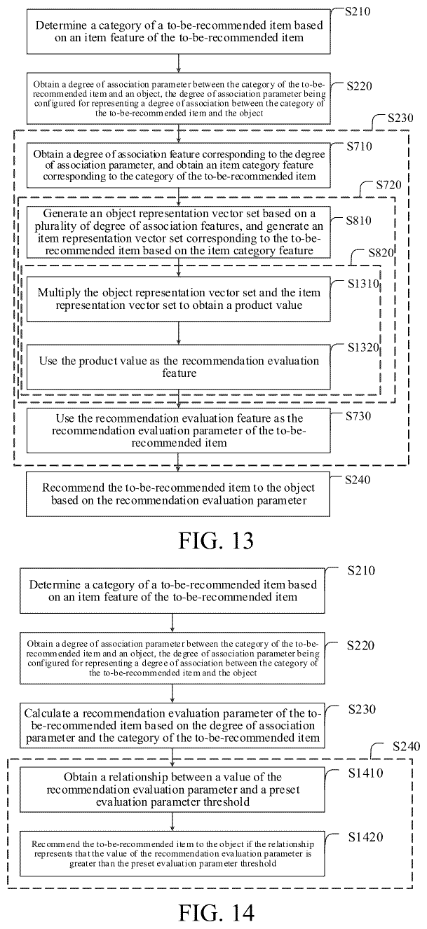

In another embodiment of this disclosure, a manner for calculating an object representation vector set and an item representation vector set is provided. Refer to FIG. 13. FIG. 13 is a schematic flowchart of another item recommendation method based on the embodiment shown in FIG. 8. The method in this embodiment is included in S820 shown in FIG. 8, and further includes at least S1310 and S1320. Details are described as follows:

S1320: Use a product value as the recommendation evaluation feature.

This embodiment is exemplarily described as follows. As shown in FIG. 10, the object representation vector set is (a first object representation vector, a second object representation vector, and a third object representation vector) and the item representation vector set is (a first item representation vector, a second item representation vector, and a third item representation vector). An inner product operation is performed on the two vector sets to obtain a corresponding value, namely, the recommendation evaluation feature.

In particular, as shown in FIG. 12, the object representation vector set is (a first object representation vector, a second object representation vector, and a third object representation vector), and the item representation vector set is (a first item representation vector, 0, and 0). A zero value is assigned to the another item representation vector other than the item representation vector corresponding to the to-be-recommended item, so that when an inner product operation is performed on the object representation vector set and the item representation vector set, only an inner product of the first object representation vector and the first item representation vector takes effect, and other calculation results are all 0. In this case, there is no difference between a direct inner product and an inner product of a common two-tower structure. To be specific, all items in a candidate pool may be scored offline in batches in advance and placed into a search library. Then, when an online request is received, embedding (representation) vectors are calculated for the object in real time for N times (where N represents a quantity of item categories) and concat (concatenation) is performed on the vectors, and then a topN item is quickly searched by directly reusing an approximate searching algorithm such as facebook AI similarity search (FAISS).

The manner for calculating the object representation vector set and the item representation vector set is provided in this embodiment. The object representation vector set is multiplied by the item representation vector set, and an obtained product value is directly used as the recommendation evaluation feature. Because there are a plurality of vectors in a relevant vector set, relevant vectors in the two vector sets are multiplied in pairs, so that an obtained product is more representative, thereby improving accuracy of the recommendation evaluation feature of the to-be-recommended item.

In another embodiment of this disclosure, how to recommend the to-be-recommended item to the object based on the recommendation evaluation parameter is described. Refer to FIG. 14. FIG. 14 is a schematic flowchart of another item recommendation method based on the embodiments shown in FIG. 2 to FIG. 5. The method in this embodiment is included in S240, and further includes at least S1410 and S1420. Details are described as follows:

S1410: Obtain a relationship between a value of the recommendation evaluation parameter and a preset evaluation parameter threshold.

The preset evaluation parameter threshold is preset, and a value of the preset evaluation parameter threshold may be configured for determining whether to recommend the to-be-recommended item to the object. The relationship described in this embodiment includes: a greater than relationship, where the value corresponding to the recommendation evaluation parameter is greater than the preset evaluation parameter threshold; an equal to relationship, where the value corresponding to the recommendation evaluation parameter is equal to the preset evaluation parameter threshold; and a less than relationship, where the value corresponding to the recommendation evaluation parameter is less than the preset evaluation parameter threshold.

If the value corresponding to the recommendation evaluation parameter is greater than the preset evaluation parameter threshold, the to-be-recommended item is recommended to the object.

For example, the relationship represents that the value corresponding to the recommendation evaluation parameter is 10, and the preset evaluation parameter threshold is equal to 5. Apparently, the relationship represents that the value corresponding to the recommendation evaluation parameter is greater than the preset evaluation parameter threshold, and in this case, the to-be-recommended item is an item recommended to the object.

In this embodiment, a case in which the value corresponding to the recommendation evaluation parameter is equal to the preset evaluation parameter threshold is not limited. To be specific, if the relationship represents that the value corresponding to the recommendation evaluation parameter is equal to the preset evaluation parameter threshold, the to-be-recommended item is recommended to the object, or the to-be-recommended item may not be recommended to the object.

In this embodiment, comparison between the value corresponding to the recommendation evaluation parameter and the preset evaluation parameter threshold is represented by using the relationship, and whether to recommend the to-be-recommended item to the object is determined based on a comparison result. Because only relevant values need to be compared, and another complex calculation process does not need to be performed, so that whether to recommend the to-be-recommended item to the object may be quickly and accurately determined, thereby improving a speed and accuracy of a determining process.

The item recommendation method in the foregoing embodiments of this disclosure may be configured for improving a recall method. An existing recall process is similar to a funnel. First, in a first stage, items that the object may be interested in need to be recalled and discovered among thousands of items. It is difficult to separately recall in all aspects, and multi-path recall is often required. Then, a second stage is pre-ranking. An input of pre-ranking generally receives thousands of inputs. In this case, ranking pressure is greatly reduced, and a more complex network structure may be appropriately used to improve data precision. Then, a third stage is ranking. An input of ranking is generally less than one thousand, and the ranking pressure becomes less. Therefore, complexity of a structure of a ranking model may also be increased to improve model precision.

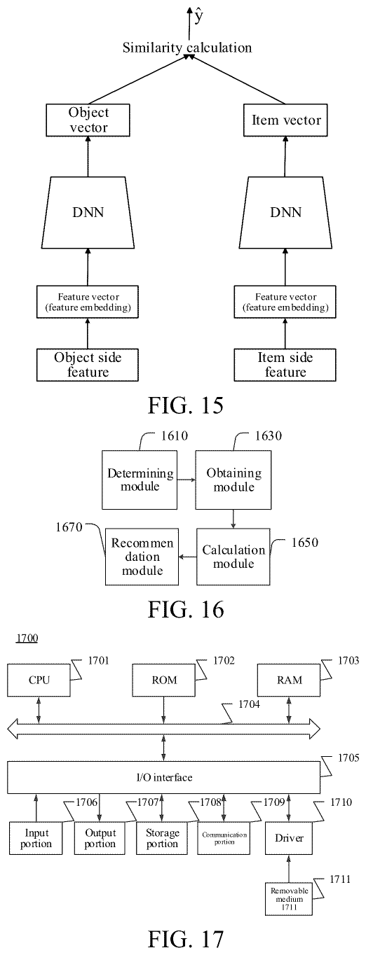

Generally, a recall model is of a two-tower structure, as shown in FIG. 15. FIG. 15 is a schematic structural diagram of an existing recall model. An object side and an item side each are a tower, and then an object vector (embedding) and an object vector (embedding) are obtained after features of the object side and the item side are respectively subjected to respective deep neural network (DNN) structures. Output dimensions of the object side and the item side need to be ensured to be consistent, this is because inner product calculation needs to be performed subsequently. In an online service, vectors of the item only need to be regularly calculated in full quantities and then stored. Then, when a request from the object arrives, an object tower is requested to calculate a feature of the object, and then a topN item that is similar to the feature of the object is found from a search library. However, a cross feature between the object and the item cannot be configured in such a network structure. If a feature related to the item is used by the object tower, all items need to be scored, and a quantity of times of scoring is proportional to a size of a candidate pool. In this case, online time consumption is high.

In another recall method, the ranking model is used. Because the input of the ranking model is generally less than one thousand, a model structure and a scoring manner may be more complex than the foregoing recall model. For example, a ranking model of a deep interest network (DIN) structure is generally used. To be specific, inner product calculation is performed on an embedding vector of a target item and an item embedding vector in a sequence of the historical behavior of the object to obtain a weight, and finally weighted summation is performed to output an interest expression of the object. Such a structure may enable the target item to activate a similar historical behavior in an object behavior, so that the target item is of greater interest than an item of another category, and the interest of the object is descried more accurately. In addition, the complexity of the ranking model may also be increased by using a binary feature, for example, a quantity of times of browsing the item and a quantity of times of transformation performed by the object in the past, so that a degree of liking of the item shown by the object may be displayed more clearly. However, because decoupling is not performed on the object and the item through the ranking model, if an online request is received once, the object and all items entering the ranking stage need to be scored. For example, if five hundred items enter the ranking stage, five hundred times of scoring need to be performed, that is, five hundred times the recall model. Therefore, the complex ranking structure is not applicable to the recall model.

An improvement idea of this disclosure for the recall method is to improve a prediction capability of the recall model without affecting time consumption of the online service. For example, to reduce the object feature to a constant level as a changing space inputted by different items is reduced, so that the object feature may be decoupled from a size of the candidate pool, an item category is introduced, and the object feature changes as the item category changes. The quantity of times of scoring corresponds to a quantity of item categories, and time consumption is reduced by reducing the quantity of times of scoring (that is, simplifying a calculation process).

In addition, in this embodiment of this disclosure, importance of the object in different item categories can be illustrated. In the embodiment shown in FIG. 5, similar to a DIN structure, attention is performed by using an embedding vector in an item category and the item embedding vector in the sequence of the historical behavior of the object, to illustrate the importance of the object in the different item categories.

Further, in the embodiment shown in FIG. 9, a concat operation is performed based on each degree of association feature and another feature of the object, and then the model learns a relationship between the item category feature and the object feature through the DNN network structure.

In this embodiment of this disclosure, a binary feature may also be formed by using the item category feature and the object feature, for example, a quantity of times of browsing and a quantity of times of transformation by the object in the target item category, and the formed binary feature is displayed for learning of the model.

In conclusion, in the embodiments of this disclosure, a degree of association feature between an object and an item is subtly introduced based on retaining a two-tower model structure, so that a model that is finally online can not only retain an agile capability of two-tower online searching, but also increase complexity of the model by using the degree of association feature. Finally, a model recall effect is improved without increasing time consumption of an online service.

An embodiment of this disclosure further provides an item recommendation apparatus. Refer to FIG. 16. FIG. 16 is a schematic structural diagram of an item recommendation apparatus according to an embodiment of this disclosure. The item recommendation apparatus includes:
a determining module 1610, configured to determine a category of a to-be-recommended item based on an item feature of the to-be-recommended item;
an obtaining module 1630, configured to obtain a degree of association parameter between the category of the to-be-recommended item and an object, the degree of association parameter being configured for representing a degree of association between the category of the to-be-recommended item and the object;
a calculation module 1650, configured to calculate a recommendation evaluation parameter of the to-be-recommended item based on the degree of association parameter and the category of the to-be-recommended item; and
a recommendation module 1670, configured to recommend the to-be-recommended item to the object based on the recommendation evaluation parameter.

In some other embodiments, the obtaining module 1630 includes:
a first obtaining unit, configured to obtain a preset degree of association parameter table, a plurality of item categories and degree of association parameters between the plurality of item categories and corresponding objects being preset in the preset degree of association parameter table; and
a matching unit, configured to determine a category matching the category of the to-be-recommended item from the preset degree of association parameter table, and obtain a degree of association parameter between the determined category and an object.

In some other embodiments, the item recommendation apparatus further includes:
an object feature obtaining module, configured to obtain an object feature of the object, and obtain item category features respectively corresponding to the plurality of item categories;
a degree of association feature generation module, configured to generate a degree of association feature between each item category and the object feature based on the object feature and an item category feature corresponding to each item category; and
a degree of association parameter determining module, configured to use the degree of association feature between each item category and the object feature as a degree of association parameter between each item category and the object.

In some other embodiments, the object feature includes a historical behavior feature of the object. The degree of association feature generation module includes:
an obtaining unit, configured to obtain an item feature associated with the historical behavior feature; and
a cross processing unit, configured to perform feature crossing on the item category feature corresponding to each item category and the associated item feature to obtain the degree of association feature between each item category and the object feature.

In some other embodiments, the calculation module 1650 includes:
a second obtaining unit, configured to obtain a degree of association feature corresponding to the degree of association parameter, and obtain an item category feature corresponding to the category of the to-be-recommended item;
a calculation unit, configured to calculate a recommendation evaluation feature of the to-be-recommended item based on the degree of association feature and the item category feature; and
an evaluation unit, configured to use the recommendation evaluation feature as the recommendation evaluation parameter of the to-be-recommended item.

In some other embodiments, there are a plurality of degree of association features. The calculation unit includes:
a vector set generation subunit, configured to generate an object representation vector set based on the plurality of degree of association features, and generate an item representation vector set corresponding to the to-be-recommended item based on the item category feature; and
a calculation subunit, configured to calculate the recommendation evaluation feature of the to-be-recommended item based on the object representation vector set and the item representation vector set.

In some other embodiments, the vector set generation subunit includes:
an object representation vector generation section, configured to generate a plurality of object representation vectors based on each degree of association feature and another feature of the object, the another feature being a feature other than the object feature for generating the degree of association feature;
an object representation vector set generation section, configured to generate the object representation vector set based on the plurality of object representation vectors;
an item representation vector generation section, configured to generate an item representation vector corresponding to the to-be-recommended item based on the item category feature and another item feature of the to-be-recommended item, the another item feature being a feature other than the item feature configured for determining the category of the to-be-recommended item; and
an item representation vector set generation section, configured to generate the item representation vector set corresponding to the to-be-recommended item based on the item representation vector corresponding to the to-be-recommended item.

In some other embodiments, the item representation vector set generation section includes:
a zero operation sub-section, configured to perform a zero operation on an item representation vector other than the item representation vector corresponding to the to-be-recommended item, to obtain an item representation vector zeroed out; and
an item representation vector set generation sub-section, configured to generate the item representation vector set corresponding to the to-be-recommended item based on the item representation vector corresponding to the to-be-recommended item and the item representation vector zeroed out.

In some other embodiments, the calculation subunit includes:
an operation section, configured to multiply the object representation vector set and the item representation vector set to obtain a product value; and
a recommendation evaluation parameter section, configured to use the product value as the recommendation evaluation feature.

In some other embodiments, the recommendation module 1670 includes:
a relationship obtaining unit, configured to obtain a relationship between a value corresponding to the recommendation evaluation parameter and a preset evaluation parameter threshold; and
a recommendation unit, configured to recommend the to-be-recommended item to the object if the relationship represents that the value corresponding to the recommendation evaluation parameter is greater than the preset evaluation parameter threshold.

The item recommendation apparatus provided in the foregoing embodiment and the item recommendation method provided in the foregoing embodiment have a same concept. Manners of modules and units for performing an operation have been described in detail in the method embodiments, and details are not described herein again.

An embodiment of this disclosure further provides an electronic device, including: a controller; and a memory, configured to store one or more programs, the one or more programs, when executed by the controller, performing the item recommendation method in the foregoing embodiments.

An embodiment of this disclosure further provides a computer-readable storage medium, having computer-readable instructions stored therein, and the computer-readable instructions, when executed by a processor of a computer, enabling the computer to perform the foregoing method. The computer-readable storage medium may be included in the electronic device described in the foregoing embodiments, or may exist alone and is not assembled into the electronic device. In addition, a computer program product is further provided, including a computer program, the computer program, when executed by a processor, implementing the foregoing item recommendation method.

Refer to FIG. 17. FIG. 17 is a schematic structural diagram of a computer system of an electronic device according to an embodiment of this disclosure. FIG. 17 is a schematic structural diagram of a computer system of an electronic device suitable for implementing the embodiments of this disclosure.

A computer system 1700 of the electronic device shown in FIG. 17 is merely an example, and does not constitute any limitation on functions and scopes of disclosure of the embodiments of this disclosure.

As shown in FIG. 17, the computer system 1700 includes a central processing unit (CPU) 1701. The CPU 1701 may perform various appropriate actions and processing based on a program stored in a read-only memory (ROM) 1702 or a program loaded from a storage portion 1708 to a random access memory (RAM) 1703, for example, perform the methods in the foregoing embodiments. The RAM 1703 further stores various programs and data required for system operations. The CPU 1701, the ROM 1702, and the RAM 1703 are connected to each other through a bus 1704. An input/output (I/O) interface 1705 is also connected to the bus 1704.

The following components are connected to the I/O interface 1705: an input portion 1706, including a keyboard, a mouse, and the like; an output portion 1707, including a cathode ray tube (CRT), a liquid crystal display (LCD), a speaker, and the like; a storage portion 1708, including a hard disk and the like; and a communication portion 1709, including a network interface card such as a local area network (LAN) card or a modem. The communication part 1709 performs communication processing through a network such as the Internet. A driver 1710 is also connected to the I/O interface 1705 as required. A removable medium 1711, such as a magnetic disk, an optical disc, a magneto-optical disk, or a semiconductor memory, is installed on the driver 1710 as required, so that a computer program read from the removable medium is installed into the storage portion 1708 as required.

According to the embodiments of this disclosure, the processes described above with reference to the flowcharts may be implemented as computer software programs. For example, an embodiment of this disclosure includes a computer program product. The computer program product includes a computer program carried on a computer-readable medium. The computer program includes a computer program configured for performing a method shown in the flowchart. In such an embodiment, the computer program may be downloaded and installed from a network through the communication portion 1709 and/or installed from the removable medium 1711. When the computer program is executed by the central processing unit (CPU) 1701, the various functions defined in the system of this disclosure are executed.

The computer-readable medium shown in the embodiments of this disclosure may be a computer-readable signal medium or a computer-readable storage medium or any combination thereof. The computer-readable storage medium may be, for example, an electrical, magnetic, optical, electromagnetic, infrared, or semiconductor system, apparatus, or device, or a combination thereof. An example of the computer-readable storage medium may include but is not limited to: an electrical connection with one or more wires, a portable computer disk, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any appropriate combination thereof. In this disclosure, the computer-readable storage medium may be any tangible medium containing or storing a program, and the program may be used by or used in combination with an instruction execution system, apparatus, or device. In this disclosure, the computer-readable signal medium may include a data signal transmitted in a baseband or as part of a carrier, and stores a computer-readable computer program. The data signal propagated in such a way may be in a plurality of forms, including, but not limited to, an electromagnetic signal, an optical signal, or any appropriate combination thereof. The computer-readable signal medium may alternatively be any computer-readable medium other than a computer-readable storage medium. The computer-readable medium may send, propagate, or transmit a program that is used by or used in conjunction with an instruction execution system, apparatus, or device. The computer program included in the computer-readable medium may be transmitted by using any suitable medium, including but not limited to: a wireless medium, a wired medium, or the like, or any appropriate combination thereof.

Related units described in the embodiments of this disclosure may be implemented in a software manner, or may be implemented in a hardware manner, and the units described may also be set in a processor. Names of these units do not constitute a limitation on the units in a specific case.

An embodiment of this disclosure further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device executes the item recommendation method provided in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely examples of embodiments of this disclosure, and are not intended to limit the implementations of this disclosure. In some examples, variations or modifications can be made based on the main idea and spirit of this disclosure.

What is claimed is:

1. A method of item recommendation, the method comprising:
determining a category of a to-be-recommended item based on an item feature of the to-be-recommended item;
obtaining an association parameter between the category of the to-be-recommended item and a first object, the association parameter representing an association level between the category of the to-be-recommended item and the first object;
calculating a recommendation evaluation parameter of the to-be-recommended item based on the association parameter and the category of the to-be-recommended item; and
determining whether to recommend the to-be-recommended item to the first object based on the recommendation evaluation parameter.

2. The method according to claim 1, wherein the obtaining the association parameter comprises:
obtaining a preset association parameter table, the preset association parameter table comprising a plurality of item categories and respective preset association parameters of the plurality of item categories to objects including the first object;
determining a matching item category to the category of the to-be-recommended item from the preset association parameter table; and
obtaining a preset association parameter between the matching item category and the first object from the preset association parameter table.

3. The method according to claim 2, further comprising:
obtaining an object feature of the first object;
obtaining respective item category features of the plurality of item categories;
for each item category:
generating a respective association feature between the respective item category and the object feature based on respective item category feature and the object feature; and
using the respective association feature between the respective item category and the object feature as a respective association parameter between the respective item category and the first object.

4. The method according to claim 3, wherein:
the object feature comprises a historical behavior feature of the first object; and the generating comprises:
obtaining an item feature associated with the historical behavior feature of the first object; and
performing feature crossing on the respective item category feature of the respective item category and the item feature to obtain the respective association feature between the respective item category and the object feature.

5. The method according to claim 1, wherein the calculating the recommendation evaluation parameter comprises:
obtaining one or more association features corresponding to the association parameter;
obtaining an item category feature of the category of the to-be-recommended item;
calculating a recommendation evaluation feature of the to-be-recommended item based on the one or more association features and the item category feature; and
using the recommendation evaluation feature as the recommendation evaluation parameter of the to-be-recommended item.

6. The method according to claim 5, wherein:
the one or more association features include a plurality of association features; and
the calculating the recommendation evaluation feature comprises:
generating an object representation vector set based on the plurality of association features;
generating an item representation vector set of the to-be-recommended item based on the item category feature; and
calculating the recommendation evaluation feature of the to-be-recommended item based on the object representation vector set and the item representation vector set.

7. The method according to claim 6, wherein:
the generating the object representation vector set comprises:
generating a plurality of object representation vectors based on the plurality of association features and a second object feature of the first object, the second object feature being a different feature from a first object feature for generating the plurality of association features; and
generating the object representation vector set based on the plurality of object representation vectors; and
the generating the item representation vector set comprises:
generating an item representation vector corresponding to the to-be-recommended item based on the item category feature and a second item feature of the to-be-recommended item, the second item feature being a different feature from the item feature that is used to determine the category of the to-be-recommended item; and
generating the item representation vector set of the to-be-recommended item based on the item representation vector corresponding to the to-be-recommended item.

8. The method according to claim 7, wherein the generating the item representation vector set comprises:
generating the item representation vector set with the item representation vector corresponding to the to-be-recommended item and with other item representation vectors in the item representation vector set being zeroed out.

9. The method according to claim 6, wherein the calculating the recommendation evaluation feature comprises:
multiplying the object representation vector set and the item representation vector set to obtain a product value; and
using the product value as the recommendation evaluation feature.

10. The method according to claim 1, wherein the determining whether to recommend the to-be-recommended item comprises:
comparing the recommendation evaluation parameter to a preset evaluation parameter threshold; and
determining to recommend the to-be-recommended item to the first object when the recommendation evaluation parameter is greater than the preset evaluation parameter threshold.

11. An information processing apparatus, comprising processing circuitry configured to:
determine a category of a to-be-recommended item based on an item feature of the to-be-recommended item;
obtain an association parameter between the category of the to-be-recommended item and a first object, the association parameter representing an association level between the category of the to-be-recommended item and the first object;
calculate a recommendation evaluation parameter of the to-be-recommended item based on the association parameter and the category of the to-be-recommended item; and
determine whether to recommend the to-be-recommended item to the first object based on the recommendation evaluation parameter.

12. The information processing apparatus according to claim 11, wherein the processing circuitry is configured to:
obtain a preset association parameter table, the preset association parameter table comprising a plurality of item categories and respective preset association parameters of the plurality of item categories to objects including the first object;
determine a matching item category to the category of the to-be-recommended item from the preset association parameter table; and
obtain a preset association parameter between the matching item category and the first object from the preset association parameter table.

13. The information processing apparatus according to claim 12, wherein the processing circuitry is configured to:
obtain an object feature of the first object;
obtain respective item category features of the plurality of item categories;
for each item category:
generate a respective association feature between the respective item category and the object feature based on respective item category feature and the object feature; and
use the respective association feature between the respective item category and the object feature as a respective association parameter between the respective item category and the first object.

14. The information processing apparatus according to claim 13, wherein
the object feature comprises a historical behavior feature of the first object; and
the processing circuitry is configured to:
obtain an item feature associated with the historical behavior feature of the first object; and
perform feature crossing on the respective item category feature of the respective item category and the item feature to obtain the respective association feature between the respective item category and the object feature.

15. The information processing apparatus according to claim 11, wherein the processing circuitry is configured to:
obtain one or more association features corresponding to the association parameter;
obtain an item category feature of the category of the to-be-recommended item;
calculate a recommendation evaluation feature of the to-be-recommended item based on the one or more association features and the item category feature; and
use the recommendation evaluation feature as the recommendation evaluation parameter of the to-be-recommended item.

16. The information processing apparatus according to claim 15, wherein
the one or more association features include a plurality of association features; and
the processing circuitry is configured to:
generate an object representation vector set based on the plurality of association features;
generate an item representation vector set of the to-be-recommended item based on the item category feature; and
calculate the recommendation evaluation feature of the to-be-recommended item based on the object representation vector set and the item representation vector set.

17. The information processing apparatus according to claim 16, wherein the processing circuitry is configured to:
generate a plurality of object representation vectors based on the plurality of association features and a second object feature of the first object, the second object feature being a different feature from a first object feature for generating the plurality of association features;
generate the object representation vector set based on the plurality of object representation vectors;
generate an item representation vector corresponding to the to-be-recommended item based on the item category feature and a second item feature of the to-be-recommended item, the second item feature being a different feature from the item feature that is used for determining the category of the to-be-recommended item; and
generate the item representation vector set of the to-be-recommended item based on the item representation vector corresponding to the to-be-recommended item.

18. The information processing apparatus according to claim 17, wherein the processing circuitry is configured to:
generate the item representation vector set with the item representation vector corresponding to the to-be-recommended item and with other item representation vectors in the item representation vector set being zeroed out.

19. The information processing apparatus according to claim 16, wherein the processing circuitry is configured to:
multiply the object representation vector set and the item representation vector set to obtain a product value; and
use the product value as the recommendation evaluation feature.

20. A non-transitory computer-readable storage medium storing instructions which when executed by at least one processor cause the at least one processor to perform:
determining a category of a to-be-recommended item based on an item feature of the to-be-recommended item;
obtaining an association parameter between the category of the to-be-recommended item and a first object, the association parameter representing an association level between the category of the to-be-recommended item and the first object;
calculating a recommendation evaluation parameter of the to-be-recommended item based on the association parameter and the category of the to-be-recommended item; and
determining whether to recommend the to-be-recommended item to the first object based on the recommendation evaluation parameter.
